(19) United States
(12) Patent Application Publication
(10) Pub. No.: US 2004/0122686 A1
(43) Pub. Date: Jun. 24, 2004

(54) Software predictive model of technology acceptance

(76) Inventors: Thomas L. Hill, Dallas, TX (US); Michael A. Frizzell, Richardson, TX (US); Marshall Treadaway, Murphy, TX (US); Joe R. Hill, Austin, TX (US); Curtis J. Connell, Plano, TX (US)

Correspondence Address: FISH & RICHARDSON P.C., 1425 K STREET, N.W., 11TH FLOOR, WASHINGTON, DC, 20005-3500, US

(21) Appl. No.: 10/326,288

(22) Filed: Dec. 23, 2002

(51) Int. Cl. G06F 17/60

(52) U.S. Cl. 705/1; 705/10

(57) ABSTRACT

Growth of the adoption of an innovation in a social group may be predicted. Web pages are designated in which to search for reference to an innovation, and each of the web pages is associated with one or more stages of innovation adoption. Data are automatically gathered concerning the frequency of reference to the innovation in the individual web pages, statistical information is derived automatically about the innovation's present stage of adoption from the gathered data and from the association of the individual web pages with one or more successive stages of technology development. A prediction of the future growth of the adoption of the innovation is made based on the statistical information.

### TECHNICAL FIELD

This invention relates to software modeling methods, and more particularly to a software predictive model of technology acceptance.

### BACKGROUND

Getting a new idea adopted, even when the idea has obvious advantages, is a difficult process. Many innovations require a lengthy period, often many years, from the time they become available until the time they are widely adopted. Knowing which innovations will be widely adopted and when they will be adopted is useful for companies that seek to plan their business strategies. However, predicting the growth and acceptance of an innovation has been notoriously difficult. Millions of inventions and innovations may be created each day, but predicting which ones will grow and flourish in society and in the marketplace is extraordinarily difficult.

### SUMMARY

In a first general aspect, growth of the adoption of an innovation in a social group may be predicted. Web pages in which to search for reference to an innovation are designated, and each of the web pages is associated with one or more stages of innovation adoption. Data are automatically gathered concerning the frequency of reference to the innovation in the individual web pages. Next, statistical information is derived automatically about the innovation's present stage of adoption from the gathered data and from the association of the individual web pages with the one or more successive stages of technology development. A prediction of the future growth of the adoption of the innovation is made based on the statistical information.

Implementations may include one or more of the following features. For example, gathering data concerning the frequency of reference to the innovation may include gathering a sum of the number of times a keyword related to the innovation appears in the individual web pages. Deriving statistical information about the innovation's stage of adoption may include deriving a histogram of how often a keyword related to the innovation appears in all web pages associated with each stage of innovation adoption. Associating each of the web pages with one or more stages of innovation adoption may include associating each of the web pages with a stage of innovation diffusion. Automatically gathering data may include launching a web spider to harvest data from the web pages and receiving data from the predetermined web pages. Predicting the future growth of the adoption of the innovation may include predicting that the innovation will move from its present stage of adoption to the stage of adoption succeeding its present stage of adoption.

In a second general aspect, a system for predicting growth of the adoption of an innovation in a social group includes a memory configured to store an index of web pages in which to search for reference to the innovation and a processor. The processor is configured to associate each of the web pages with one or more stages of innovation adoption, to automatically gather data concerning the frequency of reference to the innovation in the individual web pages, to automatically derive statistical information about the innovation's present stage of adoption from the gathered data and from the association of the individual web pages with one or more successive stages of technology development, and to predict the future growth of the adoption of the innovation based on the statistical information.

Other features will be apparent from the description and drawings, and from the claims.

### DESCRIPTION OF DRAWINGS

FIG. 1 is a schematic diagram of a system for predictively modeling innovation acceptance.

FIG. 2 is a representative plot of the adoption of three innovations as a function of time.

FIG. 3 is a representative distribution of different classes of innovation adopters.

FIG. 4 is a flow chart showing a process for identifying an innovation and defining the innovation by keywords.

FIG. 5 is a flow chart of a process for gathering data for tracking the growth and acceptance of an innovation.

FIG. 6 is a flow chart of a process for analyzing data gathered in the process shown in FIG. 6.

Like reference symbols in the various drawings indicate like elements.

### DETAILED DESCRIPTION

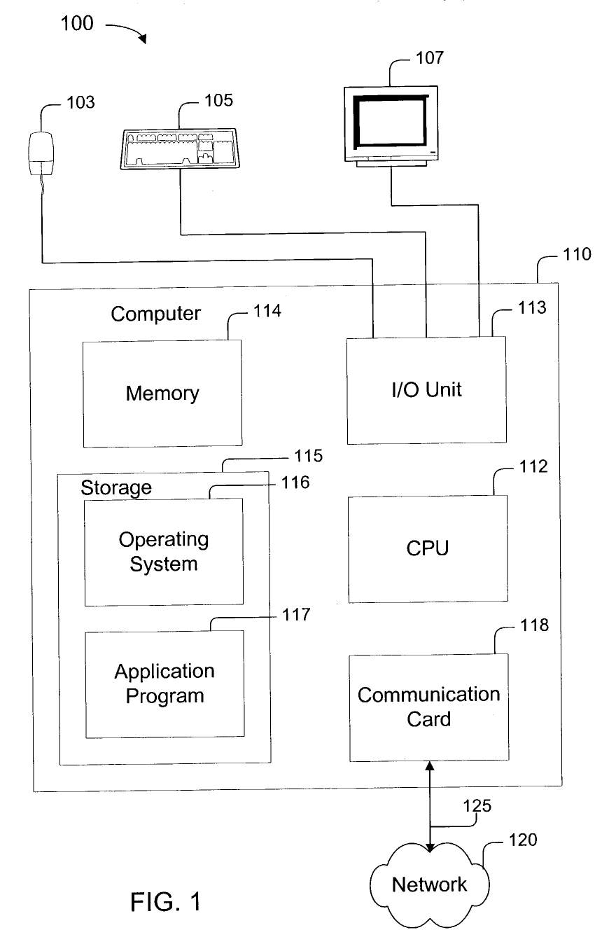

Referring to FIG. 1, exemplary components of a system 100 that may be used to model and predict the acceptance of an innovation include various input/output (I/O) devices (e.g., mouse 103, keyboard 105, and display 107) and a general purpose computer 110 having a central processor unit (CPU) 112, an I/O unit 113, memory 114, and a storage device 115. Storage device 115 may store machine-executable instructions, data, and various programs, such as an operating system 116 and one or more application programs 117, all of which may be processed by CPU 112. Each computer application may be implemented in a high-level procedural or object-oriented programming language, or in assembly or machine language if desired. The language may be a compiled or interpreted language. Data storage device 115 may be any form of non-volatile memory, including, for example, semiconductor memory devices, such as Erasable Programable Read-Only Memory (EPROM), Electrically Erasable Programable Read-Only Memory (EEPROM), and flash memory devices; magnetic disks such as internal hard disks and removable disks; magneto-optical disks; and Compact Disc Read-Only Memory (CD-ROM).

Computer system 110 may also include some sort of communications card or device 118 (e.g., a modem or a network adapter) for exchanging data with a network 120 (e.g, the Internet) through a communications link 125 (e.g., a telephone line, a wireless network link, a wired network link, or a cable network). Other systems, such as a computer system, similar to the system shown in FIG. 1, may be connected to computer system 110 through network 120 and may exchange data, information, and instructions with computer system 110. Other examples of system 100 include a handheld device, a workstation, a server, a device, a component, other equipment of some combination thereof capable of responding to and executing instructions in a defined manner. Any of the foregoing may be supplemented by, or incorporated in, application-specific integrated circuits (ASICs).

The system 100 may be used in generating and applying models of the growth and acceptance of innovations. Retrospective analysis of the growth and acceptance of particular innovations has lead to the development of models of the growth and acceptance of innovations. The diffusion of innovation model, described in Diffusion of innovations, by Everett M. Rogers (The Free Press, 4^{th} ed., New York 1995), is a model that has been widely cited for empirically modeling the growth and acceptance of innovations. A brief overview of the basic elements of this model follows.

Diffusion of an innovation is the process by which an innovation is communicated over time among the members of a social system. Diffusion of an innovation is a special type of communication concerned with the spread of messages that are perceived as new ideas. The four main elements in the diffusion of new ideas are the innovation, communication channels, time, and the social system.

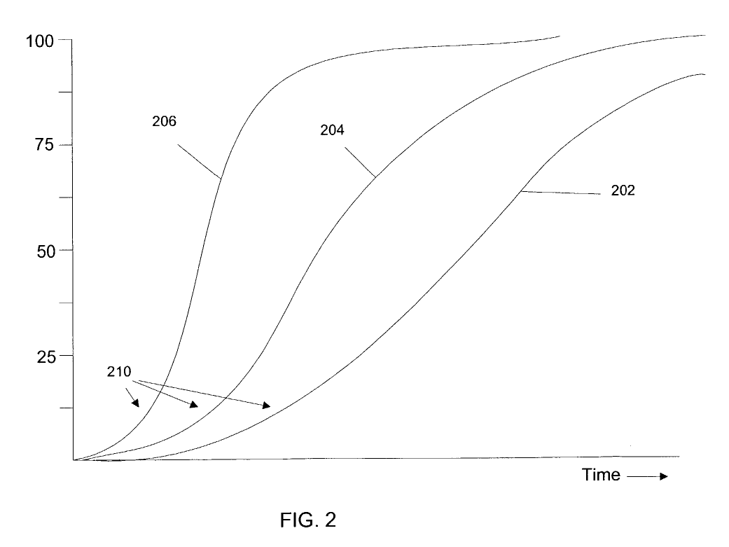

An innovation is an idea, practice, or invention that is perceived as new by an individual or other unit of adoption (e.g., a company, a business unit, or a social group). The characteristics of an innovation, as perceived by the members of a social system, determine the rate of adoption of the innovation. The characteristics may be the relative advantages of the innovation, the compatibility of the innovation, the simplicity of the innovation, the trialability of the innovation, and the observability of the innovation. FIG. 2 shows the relatively slow 202, moderate 204, and fast 206 rates of adoption for three different innovations.

The relative advantage of the innovation is the degree to which an innovation is perceived as better than the idea superseded by the innovation. The degree of relative advantage may be measured in economic terms, but social prestige, convenience, and satisfaction are also important factors. The objective value of an innovation's relative advantage is not as important as the perceived relative advantage of the innovation. The greater the perceived relative advantage of an innovation, the more rapid the rate of adoption of the innovation will be.

Compatibility is the degree to which an innovation is perceived as being consistent with the existing values, past experiences, and needs of potential adopters. An idea that is incompatible with the values and norms of a social system will not be adopted as rapidly as an innovation that is compatible. The adoption of an incompatible innovation often requires the prior adoption of a new value system, which is a relatively slow process.

Simplicity is the degree to which an innovation is perceived as difficult to understand and use. Some innovations are readily understood by most members of a social system, while others are more complicated. Innovations that are simpler to understand are adopted more rapidly than complex innovations that require the adopter to develop new skills and understandings.

Trialability is the degree to which an innovation may be experimented with on a limited basis. Innovations that can be tried on the installment plan will generally be adopted more quickly than innovations that are not divisible. An innovation that is trialable represents less uncertainty to the individual who is considering the idea for adoption, since the individual can learn by doing.

Observability is the degree to which the results of an innovation are visible to others. The easier it is for individuals to see the results of an innovation, the more likely they are to adopt the innovation. Such visibility stimulates peer discussion of a new innovation, as friends and neighbors of an adopter often request innovation-evaluation information about the innovation.

Thus, innovations that are perceived by individuals as having greater relative advantage, compatibility, trialability, observability, and simplicity will be adopted more rapidly than other innovations.

The second factor in the diffusion of innovations is the communication channel by which messages get from one individual to another. Mass media channels are more effective in creating knowledge of innovations, whereas interpersonal channels are more effective in forming and changing attitudes about an innovation, and thus in influencing the decision to adopt or reject the innovation. Most individuals evaluate an innovation through the subjective evaluations of near-peers who have adopted the innovation, rather than on the basis of scientific research by experts.

The third factor in the diffusion of innovations is time. The time dimension is involved in diffusion in three ways. First, time is involved in the innovation-decision process. The innovation-decision process is the mental process through which an individual (or other decision-making unit) moves from initial knowledge of an innovation, forms an attitude toward the innovation, makes a decision to adopt or reject the innovation, and implements the innovation. An individual may seek information at various stages in the innovation-decision process in order to decrease uncertainty about an innovation's expected consequences. The second way in which time is involved in diffusion is in the innovativeness of an individual or other unit of adoption. Innovativeness is the degree to which an individual or other unit of adoption is relatively earlier in adopting innovations than other members of a social system.

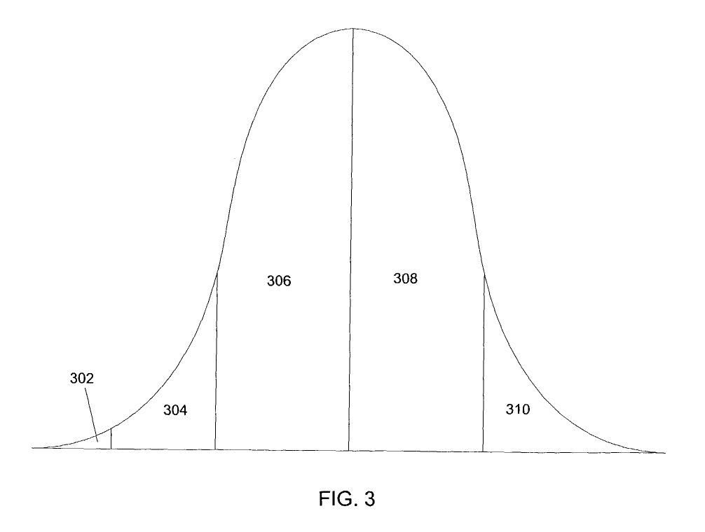

Five classifications of the members of a social system based on their innovativeness may be defined: innovators, early adopters, early majority, late majority, and laggards. FIG. 3 shows a statistical distribution 300 of the adopters from the five different adoption classifications. Innovators 302 may be defined as the first 2.5 percent of the individuals in a system to adopt an innovation. The early adopters 304 may be defined as the next 13.5 percent of the individuals in a system to adopt an innovation. The early majority 306 may be defined as the next 34 percent of the individuals in a system to adopt an innovation. The late majority 308 may be defined as the next 34 percent of the individuals in a system to adopt an innovation. Finally, the laggards 310 may be defined as the last 16 percent of the individuals in a system to adopt an innovation.

Similarly, five stages of innovation diffusion may be defined to roughly correspond to when the five different classes of adopters are most active. The five stages are emergence, adoption, production, avoidance, and extinction. The names of the five stages are intended to convey that, as an innovation progresses through the lifecycle of diffusion, the innovation first emerges as a possible innovation due to the efforts of the innovators; the innovation is initially adopted by the early adopters; the innovation achieves mass distribution and production due to its adoption by the early majority; the innovation is avoided and only reluctantly adopted by the late majority; and the innovation eventually goes into extinction when only the laggards are adopting the innovation.

Venturesomeness is almost an obsession with innovators. This interest in innovations leads them out of a local circle of peer networks and into more cosmopolitan social relationships. Communication patterns and friendships among a clique of innovators are common, even though the geographical distance between the innovators may be considerable. Being an innovator has several prerequisites. For example, financial independence or indifference is helpful to absorb the possible loss from an unprofitable innovation. The ability to understand and apply complex technical knowledge is also needed. The innovator must be able to cope with a high degree of uncertainty about an innovation at the time of adoption. While an innovator may not be respected by the other members of a social system, the innovator plays an important role in the diffusion process (i.e., that of launching the innovation in the system by importing the innovation from outside of the system's boundaries). Thus, the innovator plays a gatekeeping role in the flow of innovations into a system.

Early adopters are a more integrated part of the local system than are innovators. Whereas innovators are cosmopolites, early adopters are localites. This adopter category, more than any other, has the greatest degree of opinion leadership in most systems. Potential adopters look to early adopters for advice and information about the innovation, and early adopters act as local missionaries for speeding the diffusion process. Because early adopters are not too far ahead of the average individual in innovativeness, they serve as a role-model for many other members of a social system. The early adopter is respected by his or her peers, and is the embodiment of successful, discrete use of innovations. The early adopter knows that to continue to earn this esteem of colleagues, and to maintain a central position in the communication networks of the system, he or she must make judicious innovation-decisions. The early adopter decreases uncertainty about a innovation by adopting the innovation and then conveying a subjective evaluation of the innovation to near-peers through interpersonal networks.

The early majority adopt innovations just before the average member of a system. The early majority interact frequently with their peers, but seldom hold positions of opinion leadership in a system. The early majority's unique position between the very early and the relatively late to adopt makes them an important link in the diffusion process. They provide interconnectedness in the system's interpersonal networks. The early majority are one of the two most numerous adopter categories, making up one-third of the members of a system. The early majority may deliberate for some time before completely adopting a innovation. They follow with deliberate willingness in adopting innovations, but seldom lead.

The late majority adopt innovations just after the average member of a system. Like the early majority, the late majority make up one-third of the members of a system. Adoption may be the result of increasing network pressures from peers. Innovations are approached with a skeptical and cautious air, and the late majority do not adopt until most others in their system have done so. The weight of system norms must definitely favor an innovation before the late majority are convinced. The pressure of peers is necessary to motivate adoption. Their relatively scarce resources mean that most of the uncertainty about a innovation must be removed before the late majority feel that it is safe to adopt.

Laggards are the most localite in their outlook of all adopter categories, and many are near isolates in the social networks of their system. The point of reference for the laggard is the past. Decisions are often made in terms of what has been done previously. Laggards tend to be suspicious of innovations and change agents. Resistance to innovations on the part of laggards may be entirely rational from the laggard's viewpoint, as their resources are limited and they must be certain that a innovation will not fail before they will adopt the innovation.

The third way in which time is involved in diffusion is in rate of adoption. The rate of adoption is the relative speed with which an innovation is adopted by members of a social system. The rate of adoption is usually measured as the number of members of the system that adopt the innovation in a given time period. In FIG. 2, the rate of adoption is the slope of the lines shown in the plots of percent of adoption versus time. An innovation's rate of adoption is influenced by the five perceived attributes of an innovation.

The fourth factor in the diffusion of innovations is the social system. A social system is defined as a set of interrelated units that are engaged in joint problem-solving to accomplish a common goal. The members or units of a social system may be individuals, informal groups, organizations, and/or subsystems. The social system constitutes a boundary within which an innovation diffuses. Both the structure of the social system and established behavior patterns for the members of a social system affect diffusion, as does the degree to which an individual within the social system is able to influence other individuals' attitudes or overt behavior in a desired way with relative frequency.

A final factor in understanding the nature of the diffusion process is the critical mass, which occurs at the point at which enough individuals have adopted an innovation that the innovation's further rate of adoption becomes self-sustaining. For example, referring to FIG. 2, critical mass 210 may be established while the innovation is in the process of being adopted by the first 10-30 percent of individuals who will ultimately adopt the innovation. The concept of the critical mass implies that outreach activities should be concentrated on getting the use of the innovation to the point of critical mass. These efforts should be focused on the early adopters, the 13.5 percent of the individuals in the system to adopt an innovation after the innovators have introduced the innovation into the system. Early adopters are often opinion leaders, and serve as role-models for many other members of the social system. Early adopters are instrumental in getting an innovation to the point of critical mass, and hence, in the successful diffusion of an innovation.

Based on the retrospective innovation diffusion model described above, a semi-automated, predictive model of the growth and acceptance of an innovation may be defined. Briefly, an innovation is identified (either manually or automatically by a software application), data for tracking the growth of the innovation are gathered automatically, the data are analyzed automatically, and a forecast of the acceptance or non-acceptance of the innovations is generated based on the analysis. The data are mined from URLs of particular Internet web sites that are chosen for their association with different stages of innovation diffusion, and the data are analyzed to provide information about the growth and acceptance of the innovation.

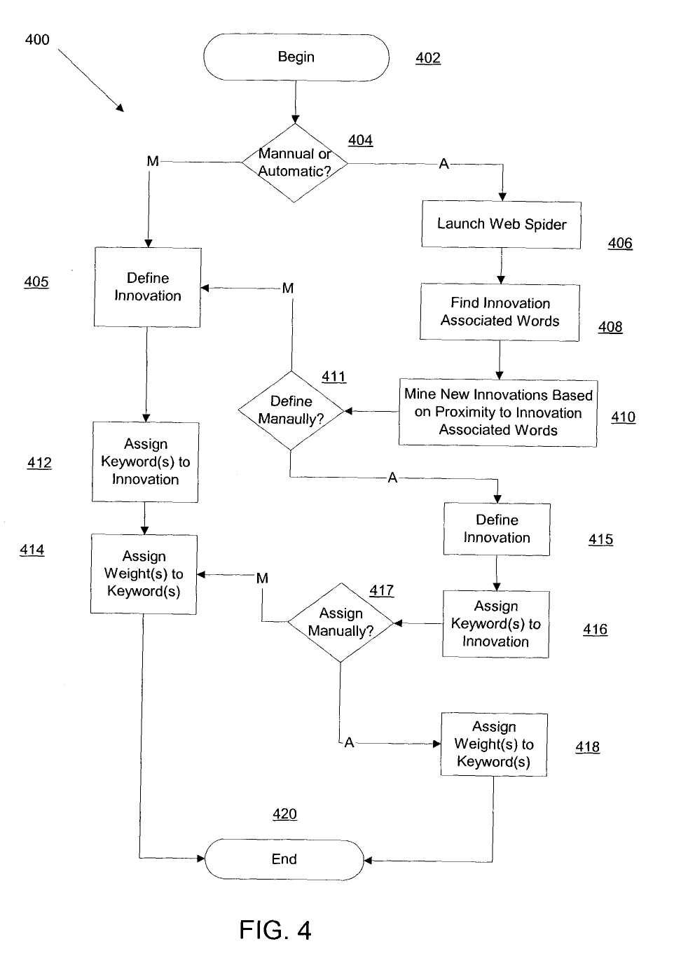

FIG. 4 shows a process 400 for identifying an innovation and defining the innovation by keywords. The process begins (step 402) and a decision is made as to whether the innovation will be defined manually or automatically (step 404). If the innovation is defined manually, a person defines an innovation (step 405), and then assigns one or more keywords to describe the innovation (step 412). For example, an innovation defined as wireless internet access may be described by assigning keywords and phrases such as “wireless internet access,” “Wi-Fi,” “802.11b,” “Blackberry,” “Bluetooth,” “broadband,” and “mobile.” Next, a weight may be assigned to each of the words defining an innovation (step 414) according to how closely the words defined match the defined innovation. The process then ends (step 420).

If the innovation is defined automatically or semi-automatically, a web spider is launched to look for new innovations (step 406). The spider may search the entire web or may search certain web sites that are associated with innovation, such as, for example, web sites of institutions associated with basic research, web sites associated with high technology venture capitalists, and web sites of media organization that report on innovations. The web spider may look for words and phrases associated with innovation (step 408), such as, for example, “innovation,” “early stage,” “start-up,” “invention,” and “novel,” and then may look for nearby words that do not appear in the standard lexicon at the time of the search, such as, for example “802.11b,” “Bluetooth,” “mainframe,” “nanotechnology,” “VCR,” “CD-ROM,” “OS/2,” “DOS,” “Walkman,” “Gameboy,” and DDT,” for use in describing new innovations (step 410). Alternatively, words that are not in a standard lexicon may be taken as words associated with an innovation, regardless of their proximity to any words associated with innovations.

These newly-identified words may be used to define an innovation, either manually or automatically (step 411). If the innovation is defined manually, the newly identified words may be presented to a user who may select one or more of the words to define an innovation (step 405), use one or more of the newly identified words or other words as keywords (step 412), and assign a weight to the keywords (step 414). If the innovation is defined automatically, one or more newly-identified words may be used to define the innovation (step 415).

Words may be used individually to define an innovation, or further processing may be used to define an innovation automatically. For example, associations between the words may be determined with a software application, such that, from the list of exemplary words listed above, an innovation could be defined that relates to the words and phrases 802.11b, Bluetooth, and Wi-Fi, but which excludes other words from the list of “802.11b,” “Bluctooth,” “mainframe,” “nanotechnology,” “VCR,” “CD-ROM,” “OS/2, ” “DOS,” “Walkman,” “Gameboy,” and “DDT.” These keywords are automatically assigned to define the innovation (step 416), and the weights may be assigned to the words either manually or automatically (step 417). If weights are assigned to the keywords automatically, they may be assigned on the basis of the proximity of the keywords to the innovation-associated words, on the basis of the frequency of their use, or on some other basis (step 418).

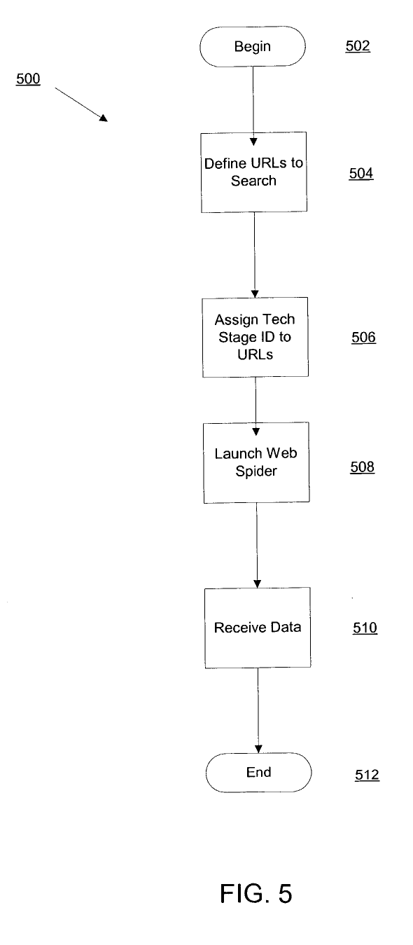

Referring to FIG. 5, once keywords defining an innovation are chosen and weights are assigned to the keywords, the process 500 of gathering data for tracking the growth and acceptance of an innovation begins (step 502). The purpose of the process 500 is to gather data for determining the current stage of diffusion of the innovation. URLs of web sites in which the keywords associated with innovations might be found are defined (step 504), and enough URLs are chosen to represent all five stages of innovation diffusion. A diffusion stage classification is tagged on each URL to define the stage of diffusion with which the URL is associated (step 506).

A web site may be viewed as a communication channel in a diffusion model of innovation adoption, and the assignment of a diffusion stage classification to a URL identifies the URL with a communication channel used primarily by a particular classification of individuals in the diffusion process or during a particular diffusion stage. For example, URLs associated with the emergence of an innovation may include URLs of web sites related to basic research, such as, for example, web sites of university laboratories, web sites of academic journal's, web sites devoted to basic research efforts by private and government organizations. URLs associated with the adoption of an innovation could be URLs of web sites of mass media organizations that follow the early stages of innovation, such as, for example, web sites of the Science Times section of The New York Times, Scientific American, and Red Herring. URLs associated with the production of an innovation may include URLs of web sites of mass media organizations reporting on the sales and marketing of an innovation, such as, for example, The Economist, The Wall Street Journal, the Business section of The New York Times, and trade journals. URLs associated with avoidance and extinction of an innovation may include URLs of auction web sites or web sites related to discount sales, such as, for example, the web sites of eBay or Wal-Mart.

The chosen URLs are used as the locations in which a web spider searches for the presence of the keywords associated with the innovation defined in process 400. A drill-down depth is also chosen for each URL to designate how many subpages of the URL homepage are searched by the web spider. A drill-down depth of two means that the URL homepage, any first level subordinate pages directly linked to the homepage, and any second level subordinate pages directly linked to the first level subordinate pages are searched. In addition, a URL normalization factor may be assigned to each URL to represent the density of information contained in the URL. This normalization factor is useful for mitigating the assignment of too much or too little significance to a web page that is relatively information dense, or too little significance to a web page that is relatively information sparse. Thus, a dense web site, such as that of The New York Times, may have a higher normalization factor than a web site from a small research lab.

The web spider is launched (step 508) and searches each URL and the desired subordinate levels for the keywords selected in process 400. The web spider counts the total number of pages it searches, the number of pages associated with each diffusion stage it searches, the total number of hits on keywords it finds, and the number of hits on keywords on web pages associated with each stage of diffusion it finds. The web spider returns the data to the host system (step 510) and the process ends (step 512).

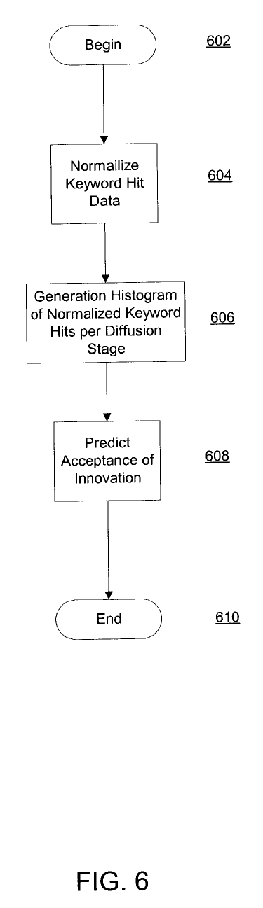

FIG. 6 shows a process 600 for analyzing the data returned in process 500 to predict the growth and acceptance of an innovation that has been defined by certain keywords in process 400. For example, the keywords used to define the wireless Internet access innovation may be “Firewire,” “802.11b,” “Wireless Internet,” “Bluetooth,” “Broadband.” The process 600 begins (step 602), and the number of hits on each keyword returned by the web spider is normalized (step 604) by multiplying the number of hits of each word by the weight assigned to the word and dividing by the URL normalization factor. The weight ensures that keywords that appear often in the selected URLs but that are not strongly related to the innovation (e.g, “Broadband” in the example above) are not given undue weight, and the normalization ensures that hits on keywords from content-rich URLs are not given undue weight with respect to hits from URLs that do not have as many pages or words per page.

The normalized number of hits on all keywords for URLs associated with different diffusion stages are then compiled (step 606). From these statistics, the stage of development of the innovation may be determined (step 608). For example, if the normalized number of hits on keywords appearing in URLs associated with the emergence, adoption, production, avoidance, and extinction diffusion stages is 3%, 21%, 38%, 32%, and 4%, respectively, it may be determined that the innovation is currently in the adoption stage of diffusion because that stage has a proportionally higher number of hits than expected from the innovation diffusion models that would predict 2.5% of the population are innovators, 13.5% are early adopters, 34% belong to the early majority, 34% belong to the late majority, and 16% belong to the laggards. From this analysis, it may be concluded that the innovation is in the emergence or adoption stage of the diffusion process, and it may be predicted that the innovation is in the process of gaining, or has recently gained critical mass, and is poised to move into the later production stages of the diffusion process.

A number of implementations have been described. Nevertheless, it will be understood that various modifications may be made and that other implementations are within the scope of the following claims.

What is claimed is:

1. A method of predicting growth of the adoption of an innovation in a social group, the method comprising:
designating web pages in which to search for reference to an innovation;
associating each of the web pages with one or more stages of innovation adoption;
automatically gathering data concerning the frequency of reference to the innovation in the individual web pages;
automatically deriving statistical information about the innovation's present stage of adoption from the gathered data and from the association of the individual web pages with one or more successive stages of technology development; and
predicting the future growth of the adoption of the innovation based on the statistical information.

2. The method of claim 1 wherein gathering data concerning the frequency of reference to the innovation comprises gathering a sum of the number of times a keyword related to the innovation appears in the individual web pages.

3. The method of claim 2 wherein automatically deriving statistical information about the innovation's stage of adoption further comprises deriving a histogram of how often a keyword related to the innovation appears in all web pages associated with each stage of innovation adoption.

4. The method of claim 1 wherein associating each of the web pages with one or more stages of innovation adoption comprises associating each of the web pages with a stage of innovation diffusion.

5. The method of claim 1 wherein automatically gathering data comprises:
launching a web spider to harvest data from the web pages; and
receiving data from the predetermined web pages.

6. The method of claim 1 wherein predicting the future growth of the adoption of the innovation comprises predicting that the innovation will move from its present stage of adoption to the stage of adoption succeeding its present stage of adoption.

7. A system for predicting growth of the adoption of an innovation in a social group, the system comprising:
a memory configured to store an index of web pages in which to search for reference to the innovation;
a processor configured to associate each of the web pages with one or more stages of innovation adoption, to automatically gather data concerning the frequency of reference to the innovation in the individual web pages, to automatically derive statistical information about the innovation's present stage of adoption from the gathered data and from the association of the individual web pages with one or more successive stages of technology development, and to predict the future growth of the adoption of the innovation based on the statistical information.

8. The system of claim 7 wherein the processor is further configured to gather a sum of the number of times a keyword related to the innovation appears in the individual web pages.

9. The system of claim 8 wherein the processor is further configured to derive a histogram of how often a keyword related to the innovation appears in all web pages associated with each stage of innovation adoption.

10. The system of claim 7 wherein the processor is further configured to associating each of the web pages with a stage of innovation diffusion.

11. The system of claim 7 wherein the processor is further configured to:
launch a web spider to harvest data from the web pages; and
receive data from the predetermined web pages.

12. The system of claim 7 wherein the processor is further configured to predict that the innovation will move from its present stage of adoption to the stage of adoption succeeding its present stage of adoption.
